(19) United States
(12) Patent Application Publication
(10) Pub. No.: US 2003/0122928 A1
(43) Pub. Date: Jul. 3, 2003

(54) Image input device and method

(75) Inventor: Norikazu Yokonuma, Tokyo (JP)

Correspondence Address: OLIFF & BERRIDGE, PLC, P.O. BOX 19928, ALEXANDRIA, VA, 22320, US

(73) Assignee: NIKON CORPORATION, CHIYODA-KU (JP)

(21) Appl. No.: 10/375,070

(22) Filed: Feb. 28, 2003

Related U.S. Application Data
(63) Continuation of application No. 09/116,467, filed on Jul. 16, 1998, now abandoned.

(30) Foreign Application Priority Data
Jul. 16, 1997 (JP) 09-191628

(51) Int. Cl. H04N 5/253

(52) U.S. Cl. 348/96

(57) ABSTRACT

An image input device has improved brightness adjustment responsiveness and a high display quality. In particular, a brightness adjustment circuit, which adjusts the brightness sensitivity of an imaging circuit, is halted from operating during the time when the film is being transferred (conveyed) through the image input device.

### INCORPORATION BY REFERENCE

The disclosure of the following priority application is herein incorporated by reference: Japanese Patent Application No. 9-191628, filed Jul. 16, 1997.

### BACKGROUND OF THE INVENTION

1. Field of Invention

The present invention relates to an image input device that converts an image that is optically recorded, for example on developed photographic film, to electrical signals that can be displayed on a display such as on a personal computer.

2. Description of Related Art

An image input device is known that shoots an already-developed photographic film with a CCD camera and outputs the image of each frame (of the photographic film) as an image signal such as a video signal. In this type of device, it is possible to sequentially locate each frame of the film adjacent to the CCD camera by hand or by transferring and feeding the film using a feeding mechanism. The CCD camera performs brightness adjustment (AE) based upon its output, and sets an appropriate AE level for each frame.

However, in conventional devices, the brightness adjustment operation is performed even during transferring and feeding of the film. Therefore, whenever the non-exposed parts of the film, located between frames of the film, are shot by the CCD camera, the brightness adjustment operation is affected by the non-exposed parts, and the AE level unnecessarily fluctuates. Thus, after the frame to be shot is located in the imaging position, the response time to reach the appropriate AE level becomes long, the brightness of the display repeatedly fluctuates excessively every time the frame is switched, and there is a problem of deterioration of the display quality.

### SUMMARY OF THE INVENTION

An object of the present invention is to provide an image input device and method in which the responsiveness of brightness adjustment is good and the display quality is high.

According to one aspect of the invention, in order to address the above and/or other problems, the brightness level of an image detector (such as, for example, a CCD) is halted from being adjusted when the film is being transferred through an image input device. In particular, brightness level adjustment is halted when the non-exposed areas of the film (e.g., the portions of the film located between frames and/or that do not contain an image) are being transferred past the image detector.

One embodiment of the invention relates to an image input device that converts an image of a frame of developed photographic film into electrical signals. The image input device includes a photoelectric converter (an image detector) that converts an image on the film into the electrical signals. A brightness sensitivity adjuster adjusts the brightness sensitivity of the photoelectric converter. A film conveyor transfers the film so as to sequentially locate each frame of the film at an aperture (i.e., at an image input position) of the photoelectric converter. A controller controls the conveyor and the brightness sensitivity adjuster to stop the brightness sensitivity adjustment of the photoelectric converter during transferring of the film by the film conveyor.

According to another aspect of the invention, in order to address the above and/or other problems, the brightness level of an image detector (such as, for example, a CCD) is halted from being adjusted when a portions of the film that does not contain an image (e.g., borders separating adjacent images) is being transferred past an imaging position of the image input device. In particular, brightness level adjustment is halted when the non-exposed areas of the film (e.g., the portions of the film located between frames and/or that do not contain an image) are being transferred past the image detector. As noted above, one way of determining when the brightness level adjustment should be halted is to detect when the film is being transferred through the image input device.

Other aspects of the invention relate to methods of performing image input.

Further aspects of the invention relate to a control program that includes instructions for use by a controller of an image input device so as to cause the image input device to function as detailed above. The control program can be stored on a computer-readable recording medium such as, for example, CD-ROM or in internal computer memory (e.g., a hard drive). The control program can be transmitted as a data signal embodied in a carrier wave. The data signal can be transmitted over a communications system such as, for example, the World Wide Web.

### BRIEF DESCRIPTION OF THE DRAWINGS

The invention will be described in conjunction with the following drawings in which like reference numerals designate like elements and wherein:

FIG. 1 is a schematic, block diagram of one embodiment of an image input device according to the present invention;

FIG. 2 is a flow chart showing the operation of the FIG. 1 device;

FIGS. 3A-3D are charts used to compare the operation of a device of the present embodiment and a conventional device; and

FIG. 4 is a plan view of developed photographic film.

### DETAILED DESCRIPTION OF PREFERRED EMBODIMENTS

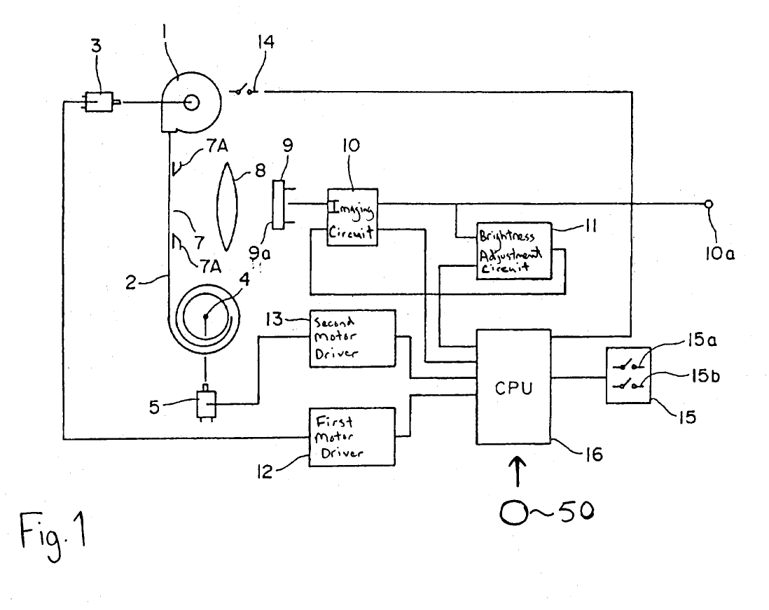

The following description explains one embodiment of an image input device according to the present invention by referring to FIGS. 1-4.

As shown in FIG. 1, a film cartridge 1 is loaded in the image input device through an aperture covered by a light shielding door (not shown). Already-developed film (e.g., negative film) 2, which is stored inside the film cartridge 1, is fed out of it. A first motor 3 rotate-drives a film spool (not shown) of the film cartridge 1 in the winding and rewinding direction of the film 2. A winding spool 4 takes-up the film 2 fed out from the film cartridge 1. A second motor 5 rotate-drives the winding spool 4 in the winding direction of the film 2.

As shown in FIG. 1, an aperture 7 is defined by an opening member 7A. The aperture 7 is the same size as the image of each frame of the film 2 fed out from the film cartridge 1, and governs the imaging region of the CCD sensor 9, which will be described later. A lens 8 is provided between the CCD sensor 9 and the film 2. The image of the frame of the film 2 is formed at the image-forming surface 9a of the CCD sensor 9 through the lens 8. The image is converted to electrical signals by the CCD sensor 9. Electrical signals output from the CCD sensor 9 are converted by imaging circuit 10 to an image signal, which is output to the output terminal 10a. A brightness adjustment circuit 11 controls the gain of the imaging circuit 10 when the electrical signals from the CCD sensor 9 are converted to the image signal. In particular, brightness adjustment circuit 11 outputs a brightness control signal to the imaging circuit 10. The gain of the imaging circuit 10 corresponds to the AE level of the brightness adjustment (AE).

As shown in FIG. 1, a first motor driver 12 drives the first motor 3, and a second motor driver 13 drives the second motor 5. A cartridge switch 14 detects the loading of the film cartridge 1. When the film cartridge 1 is loaded, the switch 14 is ON and when the cartridge 1 is not loaded, the switch 14 is OFF. An operation switch group 15 is operated by a user in order to instruct the winding, rewinding, or the like of the film 2, and includes a winding switch 15a and a rewinding switch 15b. A CPU 16 is connected to the imaging circuit 10, the brightness adjustment circuit 11, the first motor driver 12, the second motor driver 13, the cartridge switch 14, and the operation switch group 15, and controls the operation of each part of the image input device.

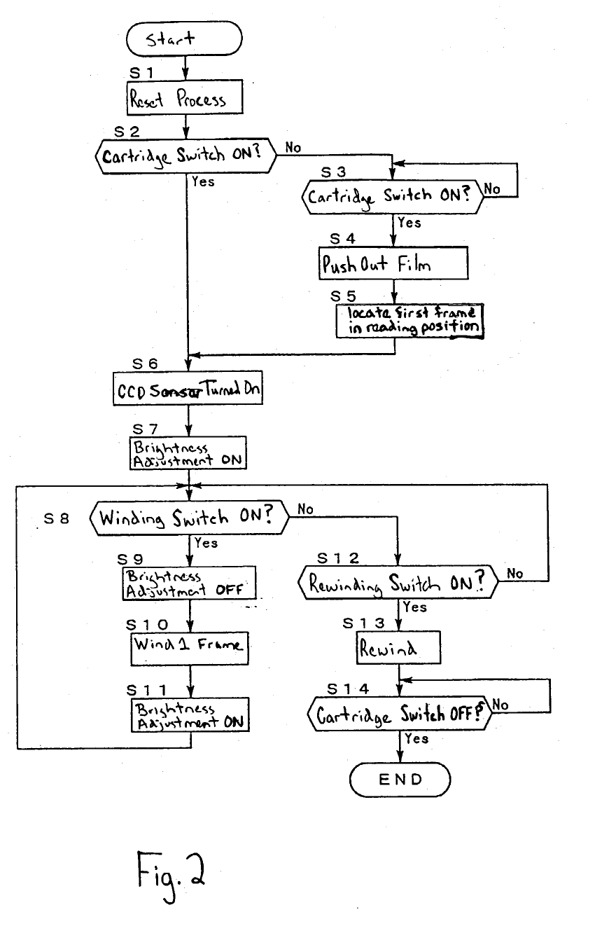

Next, the operation of the device of the present embodiment is explained with reference to FIG. 2. When the power of the device is turned ON, the operation starts from step S1 of FIG. 2. In step S1, a reset process, such as clearing the memory of the CPU 16 and resetting each circuit, is performed. In the following step S2, the state of the cartridge switch 14 is read in, and a determination is made whether the cartridge switch 14 is ON. When the film cartridge 1 is determined to be loaded, flow proceeds to step S6. On the other hand, when the cartridge switch 14 is OFF in step S2, that is, if the film cartridge 1 is determined not to be loaded, flow proceeds to step S3. Furthermore, when the film cartridge 1 is determined to be loaded in step S2, the power is again supplied to the CCD sensor 9 (step S6). At this point, a frame of the film 2 is located at the aperture 7.

When the program proceeds to step S3 after step S2, the cartridge switch 14 is read in step S3 and the program waits until the cartridge switch 14 is ON, or in other words, until the film cartridge 1 is loaded. The program then proceeds to step S4. In step S4, the first motor 3 is rotate-driven in the winding direction of the film 2 so that the film 2 is pushed out toward the winding spool 4 from the film cartridge 1 (thrust operation). In step S5, after the film 2 reaches the winding spool 4, the rotation of the first motor 3 stops and the second motor 5 is rotate-driven in the winding direction of the film 2. The second motor 5 is stopped in the position at which the first frame of the film 2 faces the aperture 7. The program then proceeds to the step S6. At this time, when the frame of the film 2 faces the aperture 7, the image-containing region on the film is governed by the aperture 7 and the image of the governed region is read by the CCD sensor 9.

When the operation of the imaging circuit 10 starts in step S6, the image signal of the image of the frame facing the aperture 7, which was taken in by the CCD sensor 9, is output through the output terminal 10a. In the following step S7, the operation of the brightness adjustment circuit 11 begins. The brightness adjustment circuit 11 observes the level of the image signal that is output by the imaging circuit 10, and the gain of the imaging circuit 10 is controlled so that the level becomes the most appropriate value.

In step S8, a state of the winding switch 15a is read. When the winding switch 15a is determined to be ON, flow proceeds to step S9. When the winding switch 15a is determined to be OFF, flow proceeds to step S12. When flow proceeds to step S9 after step S8, the operation of the brightness adjustment circuit 11 stops in step S9 and the gain of the imaging circuit 10 is fixed at the value obtained just prior to stopping the brightness adjustment circuit. In step S10, with the gain of the imaging circuit 10 being fixed (i.e., the brightness adjustment circuit 11 is turned OFF), the second motor 5 is rotated in the winding direction of the film 2. The second motor 5 stops in the position where the next frame faces the aperture 7. Next, in step S11, the operation of the brightness adjustment circuit 11 begins (i.e., it is turned ON). By this procedure, the gain of the imaging circuit 10 is adjusted to the most appropriate value corresponding to the image of the frame during shooting (imaging).

When the program proceeds to step S12 after step S8, a state of the rewinding switch 15b is read in step S12. When the rewinding switch 15b is determined to be ON, flow proceeds to step S13. When the rewinding switch 15b is determined to be OFF, flow returns to step S8. The image signal of the image of the frame facing the aperture 7 is output continuously when the results of steps S8 and S12 are NO. At such time, steps S8 and S12 are repeatedly performed until one of the switches 15a and 15b is actuated.

When the program proceeds to step S13 after step S12, in step S13, the first motor 3 is rotate-driven in the rewinding direction of the film 2 and the rewinding operation is performed until the film 2 is completely housed in the film cartridge 1. Next, in step S14, the state of the cartridge switch 14 is read. When the cartridge switch 14 is determined to be ON, step S14 is repeatedly performed. When the cartridge switch 14 is OFF, that is, when the film cartridge 1 is determined to be taken out, the sequence is completed.

As described above, in the device of the present embodiment, while the winding switch 15a is operated and the film 2 is being wound by one frame, the operation of the brightness adjustment circuit 11 temporarily stops and the gain of the image circuit 10 is fixed as it is (step S9). After the next frame is made to face the aperture 7 (step S10), the operation of the brightness adjustment circuit 11 begins (step S11). Because of this, the gain (AE level) of the imaging circuit 10 does not unnecessarily fluctuate.

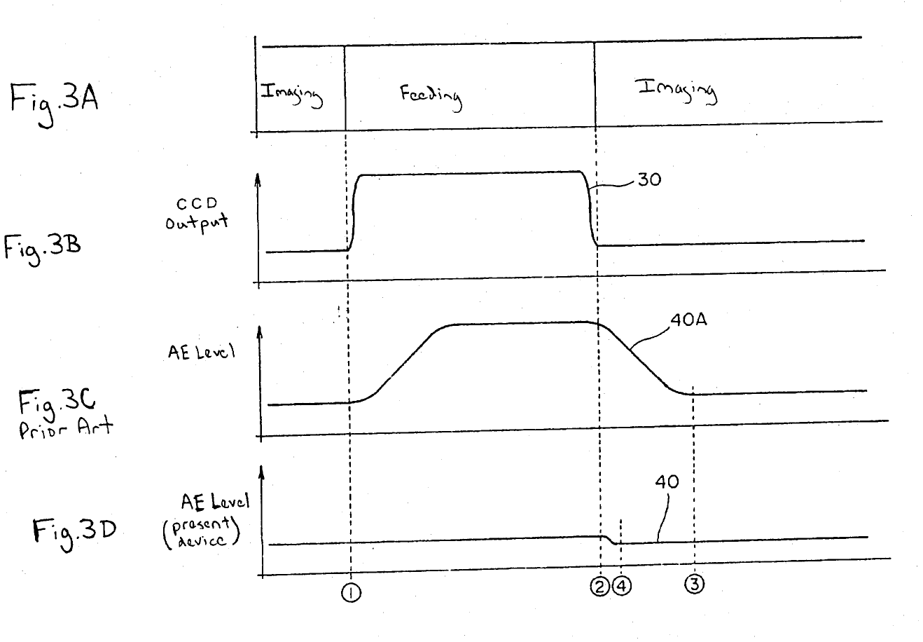

FIGS. 3A-3D compare fluctuation of the AE level in devices using the present invention and devices that do not.

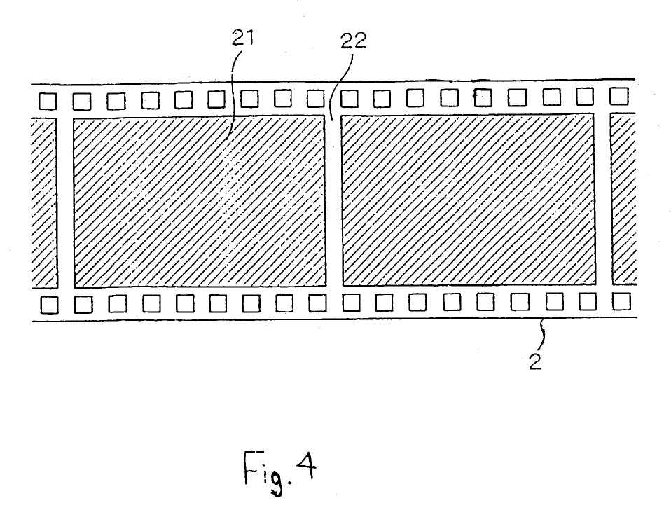

In particular, FIG. 3A illustrates the state of the image input device, FIG. 3B illustrates the CCD output, FIG. 3C illustrates the brightness adjustment circuit output of a conventional device, and FIG. 3D illustrates the brightness adjustment circuit output of an image input device according to the invention. As shown in these figures, when the feeding (winding) operation to switch the shooting to the next frame begins (\mathring{1}), the frame partition 22 of the film 2 (see FIG. 4) proceeds into the aperture 7, which causes the level of the output signal 30 of the CCD sensor 9 to increase. That is, prior to reaching position \mathring{1}, because the aperture 7 and the region of the frame image 21 coincide, the light amount incident to the CCD sensor 9 depends on the density of the frame image 21. However, the density in the frame partition 22 is extremely low due to its non-exposed condition. Thus, when the frame partition 22 proceeds into the aperture 7 through feeding of the film 2, the output signal 30 of the CCD sensor 9 rapidly rises due to the effect of the frame partition 22. When the film 2 is fed until the frame image 21 of the next frame is located in the aperture 7 (position \mathring{2}), the output signal 30 of the CCD sensor 9 rapidly drops until reaching the value corresponding to the density of the frame image 21 of the next frame.

In the device of the present embodiment, as shown in FIG. 3D, the operation of the AE level brightness adjustment circuit 11 stops during the film feeding, and the AE level 40 during that time is maintained at a certain value. After the next frame faces the aperture 7, the brightness adjustment operation begins again. Because of this operation, the fluctuation of the AE level 40 due to the effect of the frame partition 22 does not occur and the AE level does not change during the film feeding. Therefore, when feeding the film, the brightness of the display does not significantly fluctuate and the display quality of the display does not deteriorate. Furthermore, the adjustment width of the AE level is small when switching the display frame so that the time from stopping the film feeding (\mathring{2})to optimizing the AE level 40 (\mathring{4}) can be shortened. Because of this, the image of the frame after switching can be quickly displayed on the display at the appropriate brightness.

Meanwhile, the brightness adjustment operation is usually maintained in the conventional device, so, as shown in FIG. 3C, the AE level 40A gradually rises accordingly when the output signal 30 increases during the film feeding. Furthermore, when the frame image 21 of the next frame faces the aperture 7 (\mathring{2}) and the output signal 30 of the CCD sensor 9 decreases to the value corresponding to the density of the image of the next frame, the AE level 40A gradually drops accordingly.

Thus, when the film is fed in the conventional device, the AE level 40A significantly increases due to the effects of the frame partition 22, so the adjustment width of the AE level 40A to obtain the most appropriate brightness for shooting the next frame becomes extremely large. Because of this, a long period is required from the point at which the film feeding is stopped and the shooting of the next frame begins (\mathring{2}) to the point at which the appropriate brightness is obtained (\mathring{3}). Furthermore, at the point (\mathring{2}) at which the film feeding stops, the brightness of the display is extremely low and the phenomenon of the brightness increasing afterwards is repeated every time the film is fed. Accordingly, it is difficult to see the display on the screen and the display quality deteriorates.

On the contrary, in the present embodiment, the adjustment operation of the AE level stops during the film feeding and the gain of the imaging circuit 10 is kept constant. Therefore, the responsiveness to the brightness adjustment along with switching the frame is good and the display quality does not deteriorate.

In the present embodiment, the shooting operation continues during the film feeding and the image of fed film 2 is projected on the display. It is also possible to stop the output of the image signal during the film feeding operation. Furthermore, it is also possible to output some other image or the like during that (film feeding) time.

In the present embodiment, when the film is wound frame-by-frame, the adjustment operation of the AE level stops. However, for example, the invention also is applicable (to stop AE adjustment) when rewinding the film frame-by-frame or when winding or rewinding the film by a plurality of frames at a time.

The present embodiment relates to a device for displaying on a display screen such as a television monitor. However, the device of the present invention is applicable to a device for inputting the image of the film to a personal computer or the like. It is also possible to output the image output as a digital value, and to make the output terminal directly connectable to a personal computer. When applying the present invention to a device for inputting the image of the film to a personal computer or the like, the AE level can be rapidly set, so there is an advantage of shortening the input time of the image.

The type of film for the image input does not matter. It is also possible to use a film divided into several frames such as developed film of so-called 135 or 35 mm. In this case, as a moving mechanism which moves the divided film, it is also possible to feed the film by rotating a roller by a motor, for example, by providing a roller to pull the film into the cartridge after it is first entirely wound out of the cartridge.

The invention also is applicable to image input devices that read film that is held in a straight (rigid planar) film holder. The film holder can hold film having one or more frames (images). The film is conveyed (transferred) through the image input device by a mechanism that feeds the film holder.

Although the described embodiment included a film feeding mechanism (motors, etc.) to convey the film through the image input device, the invention also is applicable to image input devices through which film is manually fed. The image input device would include a sensor to sense when the film is being conveyed through the device. When conveying of the film is sensed, adjustment of the AE level is halted.

According to an aspect of the present invention, while film is being conveyed through the image input device, the brightness sensitivity adjustment of the imaging device can be stopped so that the responsiveness to the brightness adjustment is good and the display quality can be improved.

According to another aspect of the present invention, while a portion of the film that does not contain an image (e.g., a border portion of the film located between adjacent frames, and/or a leader or trailer portion of the film) is located at an imaging position of the imaging device, the brightness sensitivity adjustment of the imaging device can be stopped so that the responsiveness to the brightness adjustment is good and the display quality can be improved. The preferred embodiment accomplishes this by stopping brightness adjustment whenever the film is being fed through the image input device. This can be accomplished in other ways. For example, the non-image portions can be directly detected using, for example, a photo-detector. As another example, when the positions of the image frames are known relative to the film position (for example, based on the driving hole positions provided on the upper and lower edges of the film), the locations of non-image portions can be known by keeping track of the film position as it is fed through the image input device.

The invention further includes, as another aspect, a control program that includes instructions for use by a controller of an image input device so as to cause the image input device to function as detailed above. The control program can be transmitted as a data signal embodied in a carrier wave. The data signal can be transmitted over a communications system such as, for example, the World Wide Web. The data signal also can be transmitted in a wireless fashion, for example, by radio waves or by infrared waves. The control program can be stored in a computer-readable recording medium, such as, for example, a CD-ROM, a computer hard drive, RAM, or other types of memories that are readily removable or intended to remain fixed within the computer. A CD-ROM 50 storing the control program is illustrated in FIG. 1.

Although the described embodiment used a CCD as the image pickup (photosensor), other photosensors could be used. For example, a CMOS device or a PSD (Photo-Sensitive-Diode) also can be used as the image pickup.

In the illustrated embodiment, the image input device controller (CPU 16) is implemented using a suitably programmed general purpose computer, e.g., a microprocessor, microcontroller or other processor device (CPU or MPU). It will be appreciated by those skilled in the art, that the controller can also be implemented as a single special purpose integrated circuit (e.g., ASIC) having a main or central processor section for overall, system-level control, and separate sections dedicated to performing various different specific computations, functions and other processes under control of the central processor section. The controller can also be implemented using a plurality of separate dedicated or programmable integrated or other electronic circuits or devices (e.g., hardwired electronic or logic circuits such as discrete element circuits, or programmable logic devices such as PLDs, PLAs, PALs or the like). The controller can also be implemented using a suitably programmed general purpose computer in conjunction with one or more peripheral (e.g., integrated circuit) data and signal processing devices. In general, any device or assembly of devices on which a finite state machine capable of implementing the flow chart shown in FIG. 2 can be used as the controller.

Additionally, although the described embodiment provided a separate (dedicated) image input device controller in the housing of the image input device, the image input device also can be controlled by a controller that is separate from the housing that contains the other components (the CCD camera, the film feeding mechanism, etc.). For example, the image input device controller can be the CPU of a personal computer.

While the present invention has been described with reference to preferred embodiments thereof, it is to be understood that the invention is not limited to the disclosed embodiments or constructions. To the contrary, the invention is intended to cover various modifications and equivalent arrangements. In addition, while the various elements of the disclosed invention are shown in various combinations and configurations, which are exemplary, other combinations and configurations, including more, less or only a single element, are also within the spirit and scope of the invention.

What is claimed is:

1. An image input device comprising:
imaging means for converting an image of a frame on a film into electrical signals that represent the image;
brightness sensitivity adjusting means for adjusting a brightness sensitivity of the imaging means; and
control means for controlling the brightness sensitivity adjusting means to stop adjusting the brightness sensitivity of the imaging means when the film is moving past the imaging means.

2. The image input device of claim 1, further comprising film transferring means for transferring the film past the imaging means so as to sequentially locate a series of frames on the film at an imaging position of the imaging means, wherein the control means stops the brightness sensitivity adjusting means from adjusting the brightness sensitivity when the transferring means is transferring the film.

3. An image input device comprising:
imaging means for converting an image of a frame on a film into electrical signals that represent the image;
brightness sensitivity adjusting means for adjusting a brightness sensitivity of the imaging means; and
control means for controlling the brightness sensitivity adjusting means to stop adjusting the brightness sensitivity of the imaging means when the frame of the film is moving past the imaging means.

4. The image input device of claim 3, further comprising film transferring means for transferring the film past the imaging means so as to sequentially locate a series of frames on the film at an imaging position of the imaging means, wherein the control means stops the brightness sensitivity adjusting means from adjusting the brightness sensitivity when the transferring means is transferring the film.

5. An image input device comprising:
a photoelectric converter that converts an image on a film located at an imaging position into electrical signals that represent the image;
a brightness sensitivity adjuster, coupled to the photoelectric converter, that outputs a brightness sensitivity signal to the photoelectric converter to adjust a brightness sensitivity of the photoelectric converter; and
a controller, coupled to the brightness sensitivity adjuster, to stop the brightness sensitivity adjuster from outputting the brightness sensitivity signal to the photoelectric converter when the film is moving through the imaging position.

6. The image input device of claim 5, further comprising a film conveyor that transfers the film through the imaging position, wherein the controller stops the brightness sensitivity adjuster from outputting the brightness sensitivity signal when the film conveyor is transferring the film through the imaging position.

7. The image input device of claim 6, wherein the film conveyer includes a cartridge chamber that receives a film cartridge containing the film, a winding spool that receives film that is unwound from the film cartridge, and a driving system that conveys the film between the cartridge chamber and the winding spool past the imaging position.

8. The image input device of claim 5, wherein the controller causes the brightness sensitivity adjuster to stop outputting the brightness sensitivity signal by causing the brightness sensitivity adjuster to stop adjusting the brightness sensitivity of the photoelectric converter.

9. The image input device of claim 5, wherein the photoelectric converter includes a charge coupled device.

10. The image input device of claim 5, wherein the brightness sensitivity adjuster adjusts a gain of the photoelectric converter.

11. The image input device of claim 5, wherein the controller is a programmed central processing unit.

12. An image input device comprising:
a photoelectric converter that converts an image on a film located at an imaging position into electrical signals that represent the image;
a brightness sensitivity adjuster, coupled to the photoelectric converter, that outputs a brightness sensitivity signal to the photoelectric converter to adjust a brightness sensitivity of the photoelectric converter; and
a controller, coupled to the brightness sensitivity adjuster, to stop the brightness sensitivity adjuster from outputting the brightness sensitivity signal to the photoelectric converter when a non-image portion of the film is located at the imaging position.

13. A method of converting an image of a frame on a film into electrical signals, comprising the steps of:
converting an image of a frame on a film into electrical signals that represent the image by using a photoelectric converter;
adjusting a brightness sensitivity of the photoelectric converter; and
stopping the adjusting of the brightness sensitivity of the photoelectric converter when the film is moving past the photoelectric converter.

14. The method of claim 13, further comprising the step of intermittently transferring the film past the photoelectric converter so as to sequentially locate a series of frames on the film at an imaging position of the photoelectric converter, and wherein the brightness sensitivity adjusting is stopped when the film is being transferred.

15. The method of claim 14, wherein the film is intermittently transferred by conveying the film between a film cartridge and a winding spool past the photoelectric converter.

16. The method of claim 13, wherein the brightness sensitivity adjusting is stopped when the frame is moving past the photoelectric converter.

17. The method of claim 13, wherein the brightness sensitivity adjusting adjusts a gain of the photoelectric converter.

18. A computer data signal embodied in a carrier wave, the data signal representing a control program that is readable by a controller of an image input device that converts an image of a frame on a film into electrical signals, the control program including instructions to:
cause a photoelectric converter to convert an image of a frame on a film into electrical signals that represent the image;
adjust a brightness sensitivity of the photoelectric converter; and
stop the adjusting of the brightness sensitivity of the photoelectric converter when the film is moving past the photoelectric converter.

19. The computer data signal of claim 18, wherein the carrier wave is stored in a recording medium.
